(19) United States
(12) Patent Application Publication
(10) Pub. No.: US 2011/0263404 A1
(43) Pub. Date: Oct. 27, 2011

(54) SHEET FOLDING APPARATUS, IMAGE FORMING APPARATUS, AND SHEET FOLDING METHOD

(75) Inventor: Kyoichi Shibata, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/095,050

(22) Filed: Apr. 27, 2011

Related U.S. Application Data
(60) Provisional application No. 61/328,387, filed on Apr. 27, 2010.

(51) Int. Cl. B31B 1/26

(52) U.S. Cl. 493/405

(57) ABSTRACT

According to one embodiment, a sheet folding apparatus includes: a folding unit configured to fold a sheet to be subjected to folding; a sheet conveying unit configured to convey the sheet to be subjected to the folding to the folding unit; a conveyance control unit configured to cause the sheet conveying unit to divide, at every predetermined number of sheets, a printed document to be subjected to the folding and convey the printed document; and a folding control unit configured to control the folding unit to fold sheets with a sheet bundle to be divided and conveyed set as a unit.

### CROSS-REFERENCE TO RELATED APPLICATION(S)

This application is based upon and claims the benefit of priority from: U.S. provisional application 61/328387, filed on Apr. 27, 2010; the entire contents all of which are incorporated herein by reference.

### FIELD

Embodiments described herein relate generally to a technique for folding a sheet bundle including plural sheets.

### BACKGROUND

In the past, there are known finishing apparatuses that are mounted to an image forming apparatus and apply so-called finishing such as stapling and bookbinding to sheets on which images are formed by the image forming apparatus.

Among such finishing apparatuses, there is a finishing apparatus having a function of stapling and bookbinding a sheet bundle including plural sheets (so-called saddle stitch).

There is also known a finishing apparatus that can perform saddle folding for simply folding a sheet bundle without performing stapling if bookbinding is performed at the thickness on the order of the thickness of a booklet or if it is desired not to use staples of a stapler as much as possible for environmental protection.

In the bookbinding and the saddle folding in the finishing apparatuses in the past, sheets for all pages included in a sheet bundle to be processed are once stored in a predetermined position and folding or the like is collectively applied to a bundle of the stored sheets for all the pages.

However, in saddle folding function of the finishing apparatus in the past, it is difficult to collectively fold a sheet bundle including a large number of sheets. This is because, when a sheet bundle including a large number of folded sheets is discharged to the outside of the apparatus, it is likely that the sheet bundle is loosened and causes a sheet jam.

In the bookbinding function and the saddle folding function in the finishing apparatus in the past, if a sheet jam occurs during printing of a sheet bundle to be subjected to the bookbinding or the saddle folding, it is difficult to continue the bookbinding or the saddle folding itself. Therefore, a user has to print the sheet bundle, which should be subjected to the folding, again from the beginning.

In other words, in the finishing apparatuses in the past, sheets printed halfway before the sheet jam occurs are wasted without being subjected to the folding.

### DESCRIPTION OF THE DRAWINGS

FIG. 1 is a diagram of an example of an image forming apparatus according to a first embodiment;

FIG. 2 is a diagram of an example of a finishing apparatus according to the first embodiment;

FIG. 3 is a block diagram of an example of the configuration of the finishing apparatus according to the first embodiment;

FIG. 4 is a diagram for explaining folding in the first embodiment;

FIG. 5 is a diagram of an example of a table for managing the folding in units of the number of copies, a bundle, and the number of sheets stored in a memory when one job is executed;

FIG. 6A is a flowchart for explaining the operation of the folding;

FIG. 6B is a flowchart for explaining the operation of the folding;

FIG. 7 is a flowchart for explaining the operation of bundle discharge processing;

FIG. 8A is a flowchart for explaining the operation of the folding performed according to management of a page ID;

FIG. 8B is a flowchart for explaining the operation of the folding performed according to management of a page ID;

FIG. 9 is a block diagram of an example of the configuration of a finishing apparatus according to a second embodiment;

FIG. 10 is a block diagram of an example of the configuration of an image forming apparatus according to a third embodiment;

FIG. 11 is a flowchart for explaining the operation of the image forming apparatus according to the third embodiment; and

FIG. 12 is a flowchart for explaining the operation of the image forming apparatus according to the third embodiment (page ID management).

### DETAILED DESCRIPTION

In general, according to one embodiment, a sheet folding apparatus includes: a folding unit configured to fold a sheet to be subjected to folding; a sheet conveying unit configured to convey the sheet to be subjected to the folding to the folding unit; a conveyance control unit configured to cause the sheet conveying unit to divide, at every predetermined number of sheets, a printed document to be subjected to the folding and convey the printed document; and a folding control unit configured to control the folding unit to fold sheets with a sheet bundle to be divided and conveyed set as a unit.

In embodiments explained below, rather than collectively applying folding to all pages to be printed, all the pages are divided into bundles of a predetermined number of sheets and folding is performed with the divided bundle set as one unit.

The embodiments are explained below with reference to the accompanying drawings.

### First Embodiment

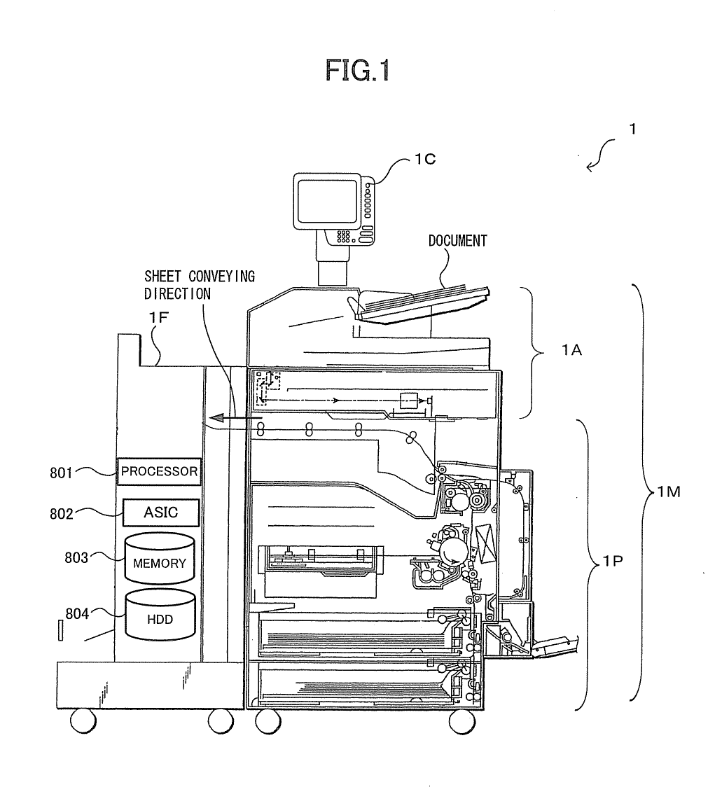

An image forming apparatus according to a first embodiment is shown in FIG. 1. An image forming apparatus 1 includes a main body unit 1M, a finishing apparatus 1F (a sheet folding apparatus), and a control panel 1C. The main body unit 1M is an MFP (Multi Function Peripheral) having functions such as a copy function, a scan function, and a facsimile transmission and reception function. The main body unit 1M includes a reading unit 1A configured to scan a document and convert a scanned image into electronic image data and an image forming unit 1P configured to form images of the electronic image data generated by the reading unit 1A and electronic data transmitted from a PC (Personal Computer).

The control-panel 1C displays processing contents and notification items of the image forming apparatus 1 to a user and receives setting of parameters and the like and a start instruction and a stop instruction for processing from the user.

The finishing apparatus 1F is an apparatus that applies folding and stapling for binding sheets to sheets after image formation conveyed from the image forming unit 1P. The finishing apparatus 1F includes a processor 801, an ASIC (Application Specific Integrated Circuit) 802, a memory 803, and a HDD (Hard Disk Drive) 804.

The processor 801 has a role of performing various kinds of processing explained later and a role of realizing various functions by executing computer programs stored in the memory 803 and the HDD 804. It goes without saying that the processor 801 can also be realized by a CPU (Central Processing Unit) or an MPU (Micro Processing Unit) that can execute arithmetic processing equivalent to that of the processor 801. Similarly, the HDD 804 can be substituted with a storage device such as a flash memory.

The memory 803 can include, for example, a RAM (Random Access Memory), a ROM (Read Only Memory), a DRAM (Dynamic Random Access Memory), an SRAM (Static Random Access Memory), a VRAM (Video RAM), or a flash memory. The memory 803 has a role of storing various kinds of information and computer programs.

Although not shown in the figure, similarly, the main body unit 1M includes a processor, an ASIC, a memory, and a HDD. The processor, the ASIC, the memory, and the HDD can be substituted in the same manner as the processor 801, the ASIC 802, the memory 803, and the HDD 804 of the finishing apparatus 1F.

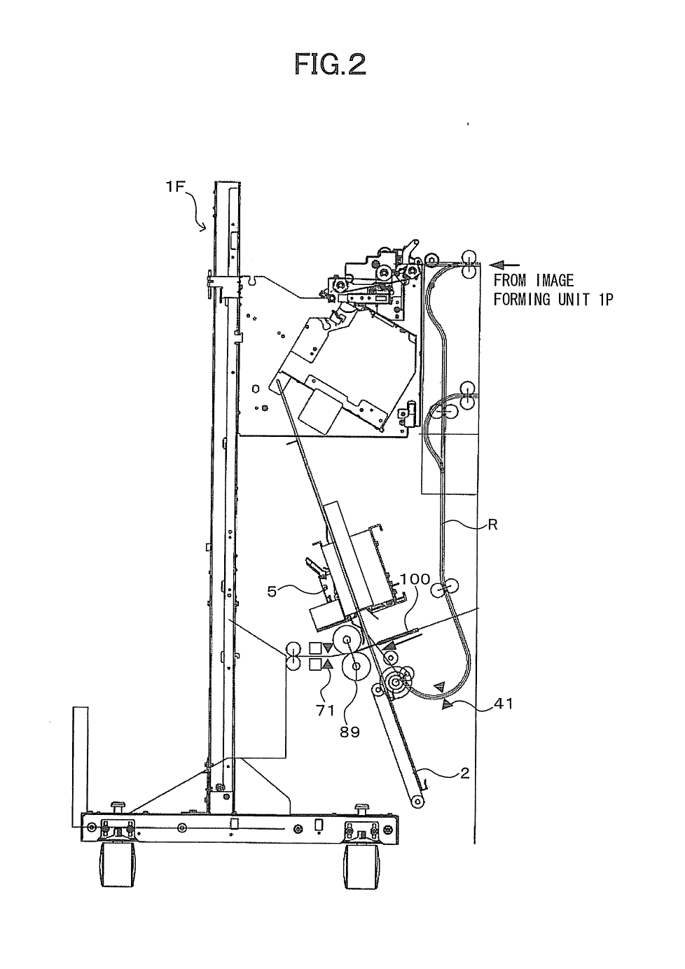

FIG. 2 is a diagram of a hardware configuration of the finishing apparatus 1F. The finishing apparatus 1F includes a conveying path R for conveying a sheet from the image forming unit 1P in the finishing apparatus 1F. A sensor 41 is a sensor for detecting presence or absence of conveyance of a sheet. The number of conveyed sheets is counted by the sensor 41. A processing tray 2 is a tray in which sheets conveyed through the conveying path R are temporarily accumulated. Sheets up to the number of sheets for one bundle (in this embodiment, five sheets) are accumulated in the processing tray 2.

A roller group 89 including two rollers and a folding blade 100 configure a mechanism for performing folding. The roller group 89 and the folding blade 100 saddle-fold sheets arranged between the roller group 89 and the folding blade 100 (fold the sheets in the center of the sheets). When the folding blade 100 moves in an arrow direction, the sheets arranged between the roller group 89 and the folding blade 100 are inserted between the two rollers of the roller group 89 while being rolled in. In this operation, the sheets receive transfer pressure from the two rollers of the roller group 89 and are folded in the sheet center. A sensor 71 is a sensor for detecting passage of the sheets to detect whether folding is performed.

The finishing apparatus 1F includes a stapling device 5 configured to execute stapling for binding sheets conveyed thereto.

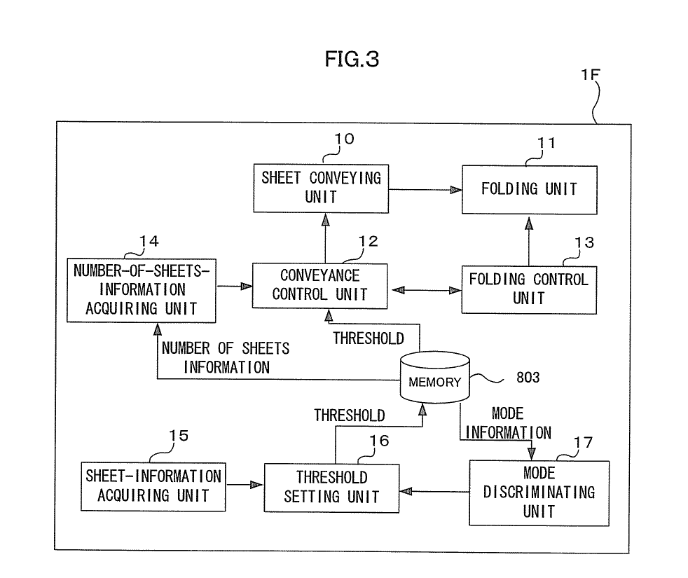

A block diagram of the finishing apparatus 1F is shown in FIG. 3. The finishing apparatus 1F includes a sheet conveying unit 10, a folding unit 11, a conveyance control unit 12, a folding control unit 13, a number-of-sheets-information acquiring unit 14, a sheet-information acquiring unit 15, a threshold setting unit 16, and a mode discriminating unit 17. These units are realized by the processor 801 loading a computer program installed in advance in the HDD 804 to the memory 803 and executing an arithmetic operation of the loaded computer program. The units are also realized in cooperation with the respective kinds of hardware shown in FIG. 2.

The folding unit 11 is a unit including the folding blade 100 and the roller group 89. The folding unit 11 folds sheets to be subjected to folding. The sheet conveying unit 10 is a unit including the conveying path R and the processing tray 2. The sheet conveying unit 10 conveys sheets to be subjected to folding to the folding unit 11 on the basis of control by the conveyance control unit 12.

The number-of-sheets-information acquiring unit 14 acquires, from the memory 803, a value of a total number of sheets in a unit of the number of copies of a printed document to be subjected to folding. Information concerning the total number of sheets is included in information concerning a print job generated during execution of printing.

The conveyance control unit 12 is a unit including the sensor 41. The conveyance control unit 12 controls the sheet conveying unit 10 to divide the printed document at every predetermined number of sheets and convey the printed document. The conveyance control unit 12 acquires a threshold from the memory 803 and performs control of the number of sheets with the threshold set as the predetermined number of sheets.

The folding control unit 13 is a unit including the sensor 71. The folding control unit 13 controls the folding unit 11 to apply folding to each divided and conveyed sheet bundle. The folding control unit 13 detects completion of the folding using the sensor 71.

The mode discriminating unit 17 discriminates an operation mode set for the folding. The mode discriminating unit 17 discriminates, for example, at least two modes, i.e., a mode in which high accuracy is not requested concerning the folding but a print needs to be provided quickly (a high-speed mode) and a mode in which high accuracy is necessary concerning the folding (a low-speed mode).

The threshold setting unit 16 is a unit configured to set a threshold used by the conveyance control unit 12. The threshold setting unit 16 sets a threshold corresponding to a result of the discrimination by the mode discriminating unit 17 among plural thresholds different from one another. For example, if the operation mode is the high-speed mode, the threshold setting unit 16 sets a threshold of a large value (i.e., since the number of times of execution of the folding is reduced, high-speed processing is performed). If the operation mode is the low-speed mode, the threshold setting unit 16 sets a threshold smaller than at least the threshold of the high-speed mode.

The sheet-information acquiring unit 15 acquires sheet information indicating a type of a sheet to be subjected to folding such as a sheet easy to be folded (a thin sheet) or a sheet difficult to be folded (a thick sheet). In addition to the setting of the threshold corresponding to the mode, the threshold setting unit 16 sets a threshold according to the type of a sheet. The threshold setting unit 16 sets the threshold small in the case of the thick sheet and sets the threshold large in the case of the thin sheet.

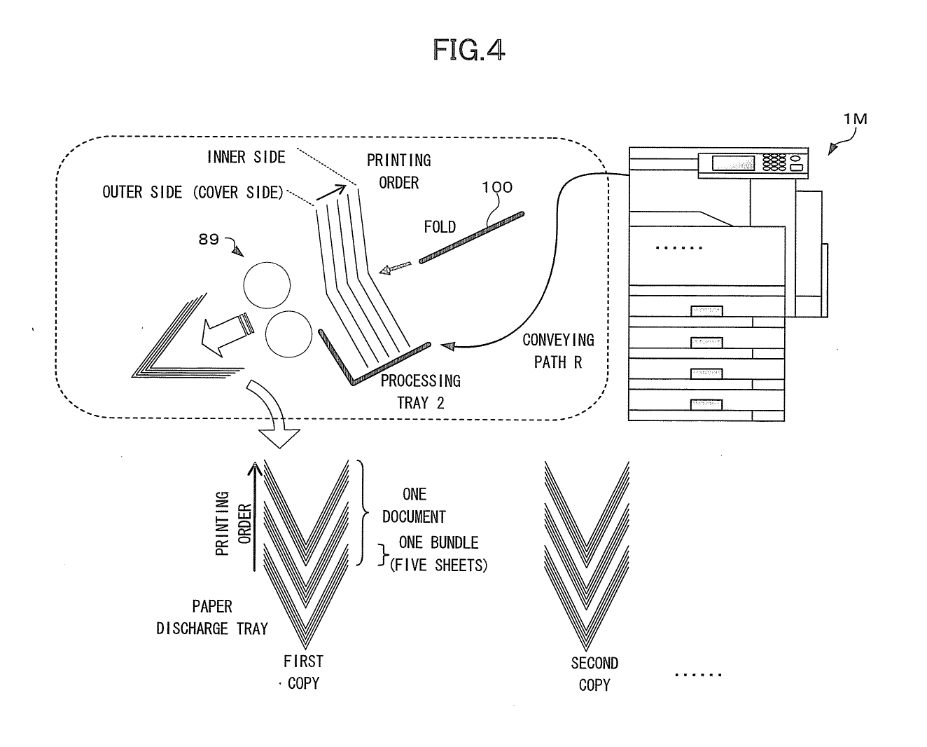

The folding in this embodiment is explained with reference to FIG. 4. In the folding in this embodiment, one document (one copy) is divided at every predetermined number of sheets and the folding is performed with the predetermined number of sheets set as one bundle. An example shown in FIG. 4 is an example in which the predetermined number of sheets is five.

Sheets output from the image forming unit 1P of the main body unit 1M are conveyed to the processing tray 2 one by one through the conveying path R. In the processing tray 2, the sheets are accumulated in order from the outer side (the cover side) to the inner side. If the number of sheets counted using the sensor 41 reaches five, a sheet bundle accumulated in the processing tray 2 is arranged between the roller group 89 and the folding blade 100. Thereafter, the folding blade 100 moves in the direction of the roller group 89 to come into contact with the center of a paper surface of the sheet bundle. The folding blade 100 further moves in the direction of the roller group 89 to be inserted between the two rollers of the roller group 89 while being accompanied by the sheet bundle. The folding is performed at every predetermined number of sheets in this way and the sheets are accumulated in a paper discharge tray. If the printing and the folding of the first copy are completed, the printing and the folding for the second copy are performed in the same manner.

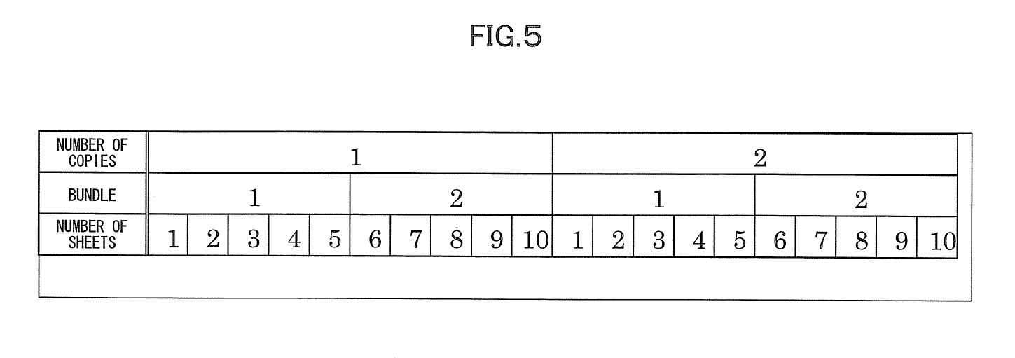

FIG. 5 is a diagram of an example of a management table stored in the memory 803 when one print job is executed. As shown in FIG. 5, the folding is managed in “the number of copies”, which is a unit indicating how many documents are printed, “bundle”, which is a unit indicating how many sheets are subjected to the folding each time, and “the number of sheets” (the number of pages), which is a unit indicating the number of sheets. Correspondence indicating which bundle is present in which copy and which pages are included in which bundle is managed. The progress is managed using the management table shown in FIG. 5 to which bundle of which copy the folding is completed.

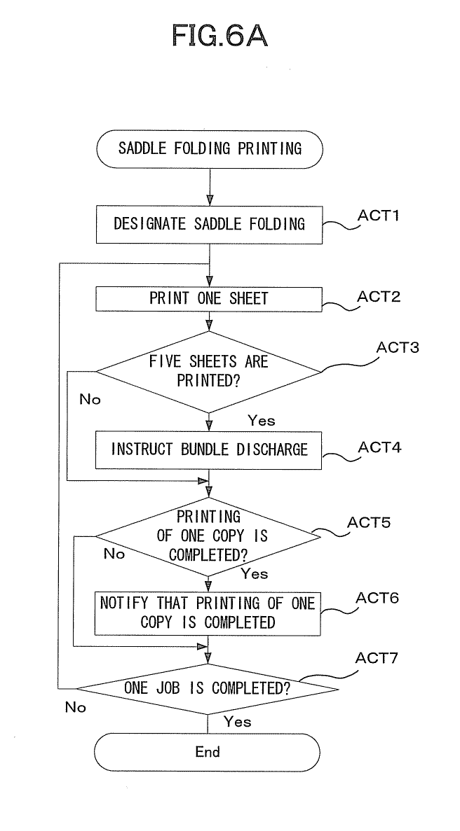

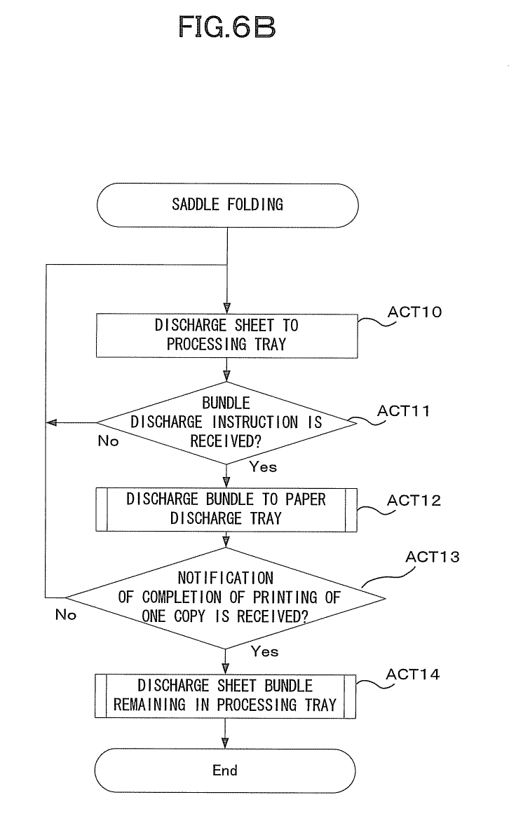

The operation of the finishing apparatus 1F is explained with reference to FIGS. 6A and 6B. In this example, a threshold is set to 5 by the threshold setting unit 16.

First, if saddle folding is designated by a user (ACT 1). The image forming unit 1P prints one sheet (ACT 2). The conveyance control unit 12 counts the number of sheets using the sensor 41 and determines whether five sheets are printed (ACT 3). If the number of sheets reaches five (Yes in ACT 3), the conveyance control unit 12 sends a discharge instruction for a bundle accumulated in the processing tray 2 to the sheet conveying unit 10 (ACT 4). On the other hand, if the number of sheets does not reach five (No in ACT 3), the processing proceeds to ACT 5.

The conveyance control unit 12 determines whether the number of printed sheets reaches a value acquired by the number-of-sheets-information acquiring unit 14 (i.e., the printing of one copy is completed) (ACT 5). If the printing of one copy is completed (Yes in ACT 5), the conveyance control unit 12 outputs notification of the completion of the printing of one copy to the sheet conveying unit 10 (ACT 6). On the other hand, if the printing of one copy is not completed (No in ACT 5), the processing proceeds to ACT 7.

The conveyance control unit 12 determines whether one print job is completed (ACT 7). If the one print job is not completed (No in ACT 7), the processing returns to ACT 2.

FIG. 6B is a flowchart for explaining the operation of the sheet conveying unit 10. The sheet conveying unit 10 conveys a sheet, on which an image is formed by the image forming unit 1P, to the processing tray 2 (ACT 10). The sheet conveying unit 10 determines whether the bundle discharge instruction sent from the conveyance control unit 12 in ACT 4 is acquired (ACT 11). If the bundle discharge instruction is acquired (Yes in ACT 11), the sheet conveying unit 10 conveys the sheet bundle accumulated in the processing tray 2 to a predetermined position (a position between the roller group 89 and the folding blade 100). Thereafter, bundle discharge processing (explained later) is performed (ACT 12). The sheet conveying unit 10 determines whether the notification of the completion of the printing of one copy is acquired (ACT 13). If the notification of the completion of the printing of one copy is received (Yes in ACT 13), the sheet conveying unit 10 conveys the sheet bundle (a fraction of sheets) remaining in the processing tray 2 to the predetermined position. The bundle discharge processing for the remaining sheet bundle is performed (ACT 14).

If the bundle discharge instruction is not received (No in ACT 11) or the notification of the completion of the printing of one copy is not acquired (No in ACT 13), the processing returns to ACT 10.

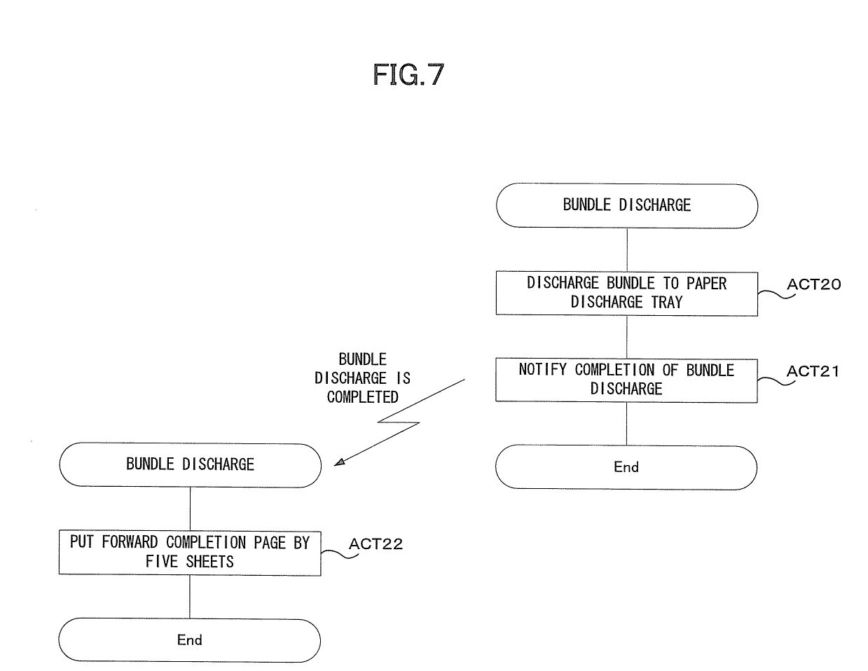

FIG. 7 is a flowchart for explaining the operation of the bundle discharge processing (ACT 12 or 14). The folding unit 11 or the folding control unit 13 discharges the bundle to the paper discharge tray (ACT 20). Processing in ACT 20 is explained. The folding control unit 13 acquires an execution instruction signal from the conveyance control unit 12 or the sheet conveying unit 10 and drives the folding unit 11. The folding unit 11 saddle-folds, on the basis of the driving control by the folding control unit 13, sheets to be subjected to the folding.

If the folding is completed, the folding control unit 13 outputs bundle discharge completion notification to the conveyance control unit 12 (ACT 21). The conveyance control unit 12 acquires the bundle discharge completion notification and updates, using the management table (see FIG. 5), information indicating to which bundle of which copy the folding is completed (ACT 22).

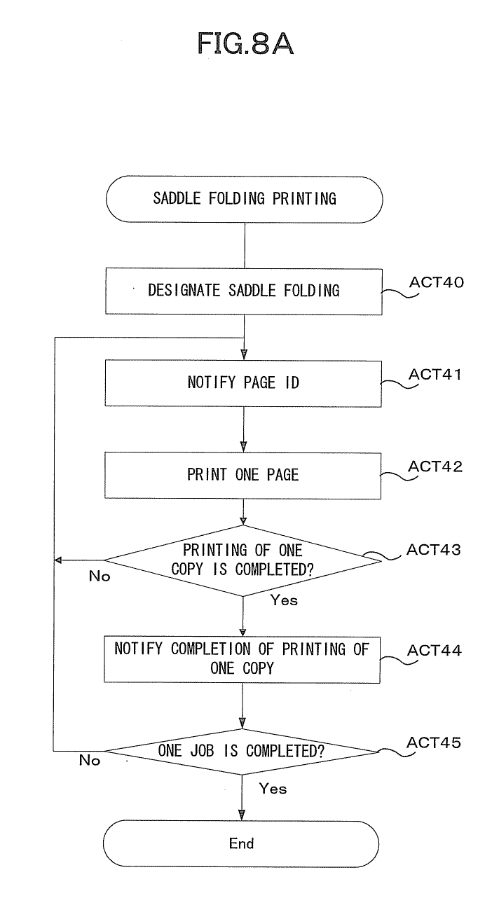

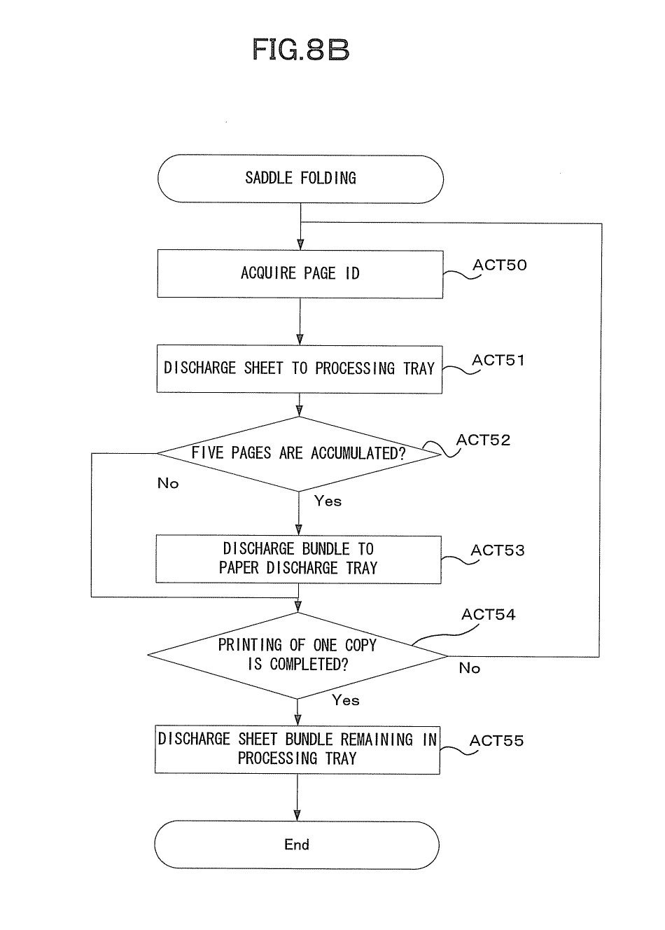

Besides the operation explained above, a method of managing sheets one by one according to identification information (a page ID) is explained with reference to flowcharts of FIGS. 8A and 8B. Processing in the image forming unit 1P is shown in FIG. 8A. Processing in the finishing apparatus 1F is shown in FIG. 8B.

If saddle folding is designated by the user (ACT 40), the image forming unit 1P notifies the finishing apparatus 1F of a page ID (ACT 41) and prints one sheet (ACT 42). The image forming unit 1P determines whether printing in copy unit is completed (ACT 43). If the printing in copy unit is completed (Yes in ACT 43), the image forming unit 1P notifies the finishing apparatus IF of the completion of the printing in copy unit (ACT 44). On the other hand, if the printing in copy unit is not completed (No in ACT 43), the processing returns to ACT 41.

The image forming unit 1P determines whether printing in job unit is completed (ACT 45). If the printing in job unit is not completed (No in ACT 45), the processing returns to ACT 41.

The operation in the finishing apparatus 1F is explained with reference to FIG. 8B. The conveyance control unit 12 acquires a page ID sent from the image forming unit 1P (Act 50). The sheet conveying unit 10 conveys a sheet to the processing tray 2 (ACT 51). The conveyance control unit 12 determines whether five sheets are accumulated in the processing tray 2 (ACT 52). If five sheets are accumulated (Yes in ACT 52), the bundle discharge processing explained with reference to FIG. 7 is performed (ACT 53). On the other hand, if five sheets are not accumulated (No in ACT 52), the processing proceeds to ACT 54.

The conveyance control unit 12 determines whether the notification of the completion of the printing in copy unit sent in ACT 44 is acquired (ACT 54). If the notification of the completion of the printing in copy unit is acquired (Yes in ACT 54), the bundle discharge processing for the remaining sheet accumulated in the processing tray 2 is performed (ACT 55) (see FIG. 7). If the notification of the completion of the printing in copy unit is not acquired (No in ACT 54), the processing returns to ACT 50.

### Second Embodiment

If a user designates saddle folding and designates stapling in a center line of sheets to be folded by the saddle folding (saddle stapling and folding), if the number of sheets exceeds an allowed number of sheets for the stapling, the finishing apparatus in the past discharges the sheets to a tray without performing anything (without performing the saddle folding). In a second embodiment, an embodiment in which only the stapling is stopped is explained.

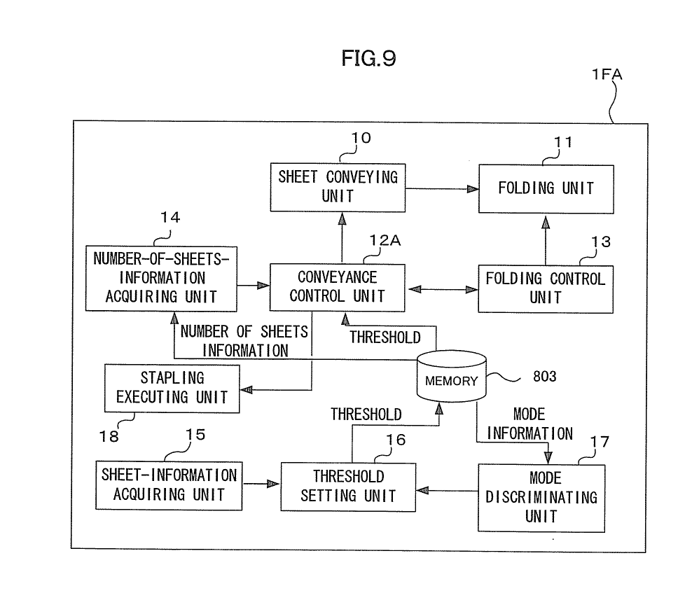

A block diagram of a finishing apparatus according to the second embodiment is shown in FIG. 9. In addition to the components of the finishing apparatus 1F explained in the first embodiment, a finishing apparatus 1FA includes a stapling executing unit 18 (equivalent to the stapling device 5 shown in FIG. 2) configured to execute stapling. In addition to the functions of the conveyance control unit 12 in the first embodiment, a conveyance control unit 12A controls the stapling executing unit 18 not to execute stapling if the number of sheets acquired by the number-of-sheets-information acquiring unit 14 exceeds a predetermined threshold. A hardware configuration of the finishing apparatus 1FA is the same as that in the first embodiment.

By adopting such a configuration, if the number of sheets of one document exceeds the predetermined threshold, the stapling is not executed and, on the other hand, the saddle folding is performed while being divided as explained in the first embodiment. Even if the number of sheets of one document is smaller than the number of sheets in bundle unit (five), the folding is always performed according to the control performed through No in ACT 3, Yes in ACT 5, ACT 6, Yes in ACT 13, and ACT 14 of the flowcharts of FIGS. 6A and 6B in this order.

If the stapling is not performed, an image forming apparatus according to the second embodiment displays “stapling is not performed because the specified number of sheets is exceeded” on the control panel 1C. According to such display, the user notices that the stapling is not performed.

### Third Embodiment

In a third embodiment, implementation for performing, if a sheet jam occurs in saddle folding, printing from the beginning of a bundle rather than performing printing again from the beginning of a copy is explained.

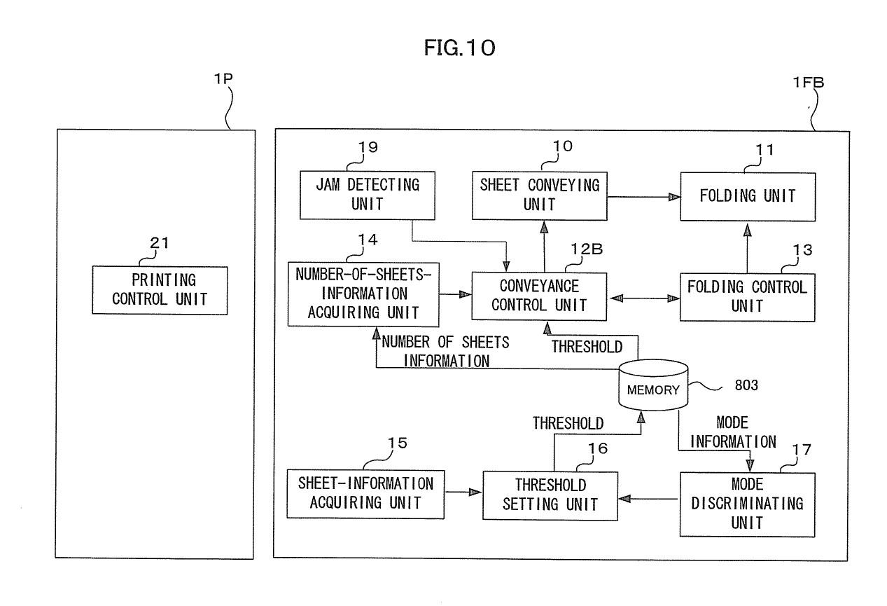

The configuration of an image forming apparatus according to the third embodiment is explained with reference to a block diagram of FIG. 10. The image forming unit 1P includes a printing control unit 21 configured to control start, suspension, and the like of printing. The printing control unit 21 performs control to suspend printing if jam occurrence notification is acquired from a conveyance control unit 12B and performs control to resume the printing if jam removal notification is acquired from the conveyance control unit 12B. The printing is resumed from a bundle not subjected to folding yet on the basis of the management table (see FIG. 5).

A finishing apparatus 1FB includes a jam detecting unit 19 and the conveyance control unit 12B. The jam detecting unit 19 is a unit including sensors such as the sensor 41 and the sensor 71. The jam detecting unit 19 detects a jam using the sensors and outputs a detection signal to the conveyance control unit 12B. In addition to the functions of the conveyance control unit 12 in the first embodiment, the conveyance control unit 12B outputs, on the basis of the detection signal from the jam detecting unit 19, the jam occurrence notification and the jam removal notification to the printing control unit 21. The other units are the same as those in the first embodiment.

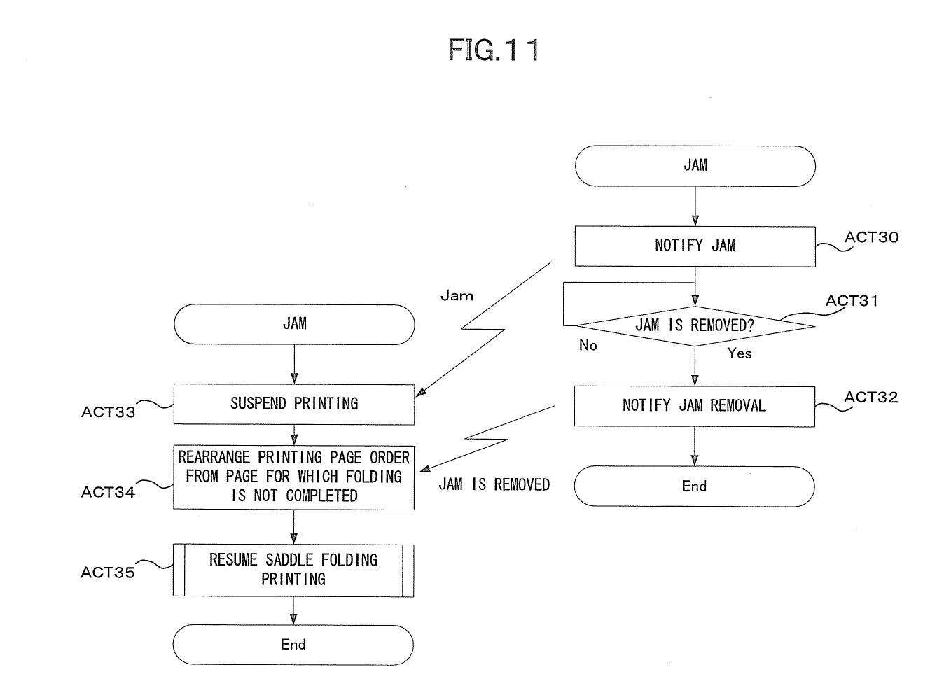

FIG. 11 is a flowchart for explaining the operation in the third embodiment. First, if the jam detecting unit 19 detects a jam, the jam detecting unit 19 outputs a detection signal to the conveyance control unit 12B. The conveyance control unit 12B notifies the printing control unit 21 that the jam occurs (ACT 30). Thereafter, if the jam is removed by work of a user (Yes in ACT 31), the conveyance control unit 12B notifies the printing control unit 21 of the removal of the jam (ACT 32).

On the other hand, if jam occurrence notification is acquired, the printing control unit 21 suspends printing (ACT 33). Thereafter, if notification of jam removal is acquired, the printing control unit 21 checks, using the management table (see FIG. 5), information indicating to which bundle of which copy the folding is completed (ACT 34). The printing control unit 21 resumes the printing from the beginning of a sheet bundle that causes the jam (ACT 35). Besides the implementation in which the printing control unit 21 checks, using the management table, to which bundle of which copy the folding is completed, implementation may be adopted in which, in the notification in ACTS 30 and 32, the conveyance control unit 12B checks the information indicating to which bundle of which copy the folding is completed and notifies the printing control unit 21 of the information.

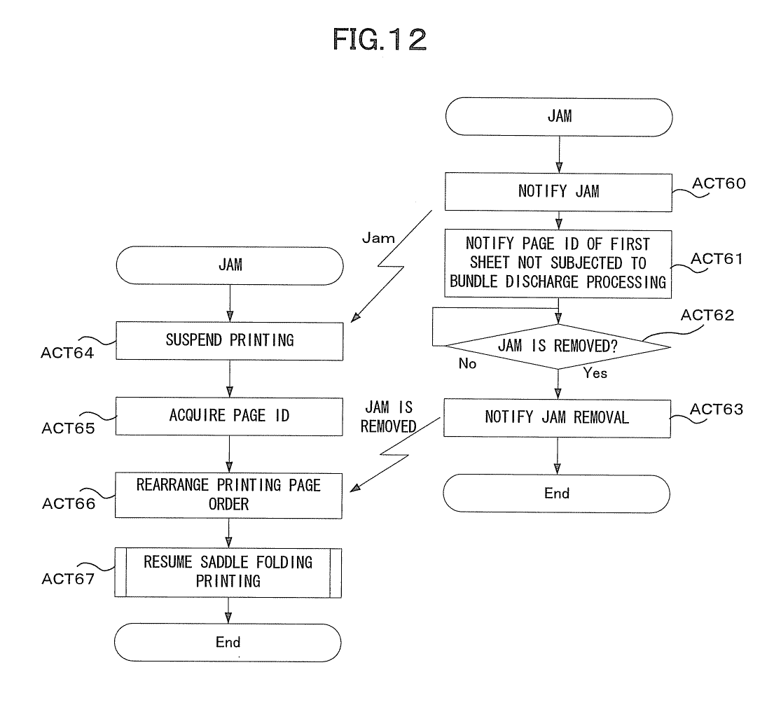

The operation of the image forming apparatus performed using a page ID is explained with reference to FIG. 12. After the detection by the jam detecting unit 19, the conveyance control unit 12B notifies the printing control unit 21 of the jam (ACT 60) and notifies the printing control unit 21 of a page ID of a first sheet not subjected to the bundle discharge processing (ACT 61). If the jam is removed (Yes in ACT 62), the conveyance control unit 12B transmits the notification of the removal of the jam to the printing control unit 21 (ACT 63).

If the notification of the jam is acquired from the conveyance control unit 12B, the printing control unit 21 suspends printing (ACT 64) and acquires the page ID notified in ACT 61 (ACT 65). If the notification of the removal of the jam notified in ACT 63 is received (ACT 63), the printing control unit 21 rearranges the order of printing pages such that the printing is resumed from a page corresponding to the acquired page ID (ACT 66) and resumes the printing (ACT 67).

By adopting such a configuration, recovery printing can be performed from the beginning of a bundle of a small number of sheets rather than from the beginning of a copy. Since it is unnecessary to reprint a bundle already normally discharged, sheets can be saved.

It goes without saying that it is also possible to cause the ASIC 802 to execute, in terms of circuit, at least a part of the various kinds of processing executed by the processor executing the computer program in the embodiments.

Among the blocks shown in FIGS. 3, 9 and 10 in the embodiments, the components other than the sheet conveying unit 10, the folding unit 11, and the stapling executing unit 18 may be included in the main body unit 1M. In this case, the folding and the stapling are realized by the respective kinds of hardware such as the processor, the memory, the HDD, and the ASIC included in the main body unit 1M and the computer program cooperating with each other.

As explained above in detail, according to the technique described in this specification, even when the folding is applied to a print including a large number of printed sheets, it is possible to easily perform the folding. Since the folding is applied to a divided small number of sheets, it is possible to reduce occurrence of a jam when the folding is performed. Even when a jam occurs, it is unnecessary to reprint all relevant copies. Therefore, it is possible to suppress consumption of sheets and toners involved in the occurrence of the jam.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet folding apparatus comprising:
a folding unit configured to fold a sheet to be subjected to folding;
a sheet conveying unit configured to convey the sheet to be subjected to the folding to the folding unit;
a conveyance control unit configured to cause the sheet conveying unit to divide, at every predetermined number of sheets, a printed document to be subjected to the folding and convey the printed document; and
a folding control unit configured to control the folding unit to fold sheets with a sheet bundle to be divided and conveyed set as a unit.

2. The apparatus according to claim 1, further comprising:
a mode discriminating unit configured to discriminate an operation mode set for the folding; and
a threshold setting unit configured to set, as the predetermined number of sheets, a threshold corresponding to a result of the discrimination by the mode discriminating unit out of plural predetermined thresholds different from one another.

3. The apparatus according to claim 2, wherein
the mode discriminating unit discriminates at least a first mode for performing processing at first processing speed and a second mode for performing processing at speed higher than the first processing speed, and
the threshold setting unit sets a first threshold if the mode discriminating unit discriminates that the operation mode is the first mode and sets a second threshold larger than the first threshold if the mode discriminating unit discriminates that the operation mode is the second mode.

4. The apparatus according to claim 1, further comprising:
a sheet-information acquiring unit configured to acquire sheet information indicating a type of the sheet to be subjected to the folding; and
a threshold-setting unit configured to set, as the predetermined number of sheets, a threshold corresponding to the sheet information acquired by the sheet-information acquiring unit out of plural predetermined thresholds different from one another.

5. The apparatus according to claim 4, wherein
the sheet information includes a value indicating thickness of the sheet, and
the threshold setting unit sets a smaller threshold as the thickness of the sheet increases.

6. The apparatus according to claim 1, further comprising a stapling executing unit configured to execute stapling on the basis of control by the conveyance control unit, wherein
the conveyance control unit controls, if a number of sheets of one document exceeds a predetermined threshold, the stapling executing unit not to execute the stapling.

7. The apparatus according to claim 1, wherein the conveyance control unit notifies, if a sheet jam occurs, an image forming unit, which forms an image on the sheet, that the sheet jam occurs and notifies, if the sheet jam is removed, the image forming unit that printing is resumed from beginning of a sheet bundle that causes the sheet jam.

8. An image forming apparatus comprising:
an image forming unit configured to form an image on a sheet;
a folding unit configured to fold a sheet to be subjected to folding;
a sheet conveying unit configured to convey the sheet, on which the image is formed by the image forming unit, to the folding unit;
a conveyance control unit configured to cause the sheet conveying unit to divide, at every predetermined number of sheets, a printed document to be subjected to the folding and convey the printed document; and
a folding control unit configured to control the folding unit to fold sheets with a sheet bundle to be divided and conveyed set as a unit.

9. The apparatus according to claim 8, further comprising:
a mode discriminating unit configured to discriminate an operation mode set for the folding; and
a threshold setting unit configured to set, as the predetermined number of sheets, a threshold corresponding to a result of the discrimination by the mode discriminating unit out of plural predetermined thresholds different from one another.

10. The apparatus according to claim 9, wherein
the mode discriminating unit discriminates at least a first mode for performing processing at first processing speed and a second mode for performing processing at speed higher than the first processing speed, and
the threshold setting unit sets a first threshold if the mode discriminating unit discriminates that the operation mode is the first mode and sets a second threshold larger than the first threshold if the mode discriminating unit discriminates that the operation mode is the second mode.

11. The apparatus according to claim 8, further comprising:
a sheet-information acquiring unit configured to acquire sheet information indicating a type of the sheet to be subjected to the folding; and
a threshold-setting unit configured to set, as the predetermined number of sheets, a threshold corresponding to the sheet information acquired by the sheet-information acquiring unit out of plural predetermined thresholds different from one another.

12. The apparatus according to claim 11, wherein
the sheet information includes a value indicating thickness of the sheet, and
the threshold setting unit sets a smaller threshold as the thickness of the sheet increases.

13. The apparatus according to claim 8, further comprising a stapling executing unit configured to execute stapling on the basis of control by the conveyance control unit, wherein
the conveyance control unit controls, if a number of sheets of one document exceeds a predetermined threshold, the stapling executing unit not to execute the stapling.

14. The apparatus according to claim 8, wherein
the conveyance control unit notifies, if a sheet jam occurs, the image forming unit of first information and notifies, if the sheet jam is removed, the image forming unit of second information, and
the image forming unit suspends the formation of the image if the first information is acquired and resumes, if the second information is acquired, the formation of the image from beginning of a sheet bundle that causes the sheet jam.

15. A sheet folding method comprising:
a sheet folding apparatus, which folds a sheet on which an image is formed, dividing, at every predetermined number of sheets, a printed document to be subjected to folding and accumulating the printed document; and
the sheet folding apparatus folding sheets with sheets to be divided and accumulated set as a unit.

16. The method according to claim 15, further comprising:
the sheet folding apparatus discriminating an operation mode set for the folding; and
the sheet folding apparatus setting, as the predetermined number of sheets, a threshold corresponding to a result of the discrimination of the mode out of plural predetermined thresholds different from one another.

17. The method according to claim 16, further comprising:
the sheet folding apparatus discriminating at least a first mode for performing processing at first processing speed and a second mode for performing processing at speed higher than the first processing speed; and
the sheet folding apparatus setting a first threshold if the sheet folding apparatus discriminates that the operation mode is the first mode and setting a second threshold larger than the first threshold if the sheet folding apparatus discriminates that the operation mode is the second mode.

18. The method according to claim 15, further comprising the sheet folding apparatus setting, as the predetermined number of sheets, a threshold corresponding to thickness of a sheet out of plural predetermined thresholds different from one another and setting a smaller threshold as the thickness of the sheet increases.

19. The method according to claim 15, wherein
the sheet folding apparatus includes a stapling executing unit configured to execute stapling, and
the method further comprises the sheet folding apparatus controlling, if a number of sheets of one document exceeds a predetermined threshold, the stapling executing unit not to execute the stapling.

20. The method according to claim 15, further comprising the sheet folding apparatus notifying, if a sheet jam occurs, an image forming unit, which forms an image on the sheet, that the sheet jam occurs and notifies, if the sheet jam is removed, the image forming unit that printing is resumed from beginning of a sheet bundle that causes the sheet jam.
